(19) United States
(12) Patent Application Publication
(10) Pub. No.: US 2004/0198549 A1
(43) Pub. Date: Oct. 7, 2004

(54) Toroidal drive with all-wheel arrangement

(76) Inventor: Jurgen Wafzig, Eriskirch (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/818,306

(22) Filed: Apr. 5, 2004

(30) Foreign Application Priority Data
Apr. 7, 2003 (DE) 103 15 682.8

(51) Int. Cl. F16H 15/36

(52) U.S. Cl. 476/39

(57) ABSTRACT

In an all-wheel toroid transmission, the distribution of the torque and the power to the front axle (7) and the rear axle (6) of the vehicle takes place via a friction wheel variator (1) for a vehicle with a friction wheel variator (1).

The present invention relates to an all-wheel toroid transmission for a vehicle according to the preamble of Patent Claim 1.

Continuously adjustable friction wheel variators equipped with at least two toroid disks with toroid-shaped contact surfaces with rollers running between them are known from prior art. Such friction wheel variators have a high torque capacity in addition to continuously adjustable translation change.

According to prior art, continuously adjustable friction wheel variators are also used in all-wheel transmissions. In addition, a transfer gearbox is used to supply the torque or the power from the front and the rear axle differential. In addition, a long side shaft is required that connects the all-wheel distributor to the front or rear axle differential. Thus, a construction like this requires a great deal of installation space, besides being heavy and expensive.

The present invention is based on the task of making available an all-wheel transmission comprising a continuously adjustable friction wheel variator and requiring fewer components than an all-wheel transmission according to prior art.

This task is achieved through the features of Patent Claim 1. Further designs and advantages result from the dependent claims.

It is, therefore, suggested to use the two output disks of the friction wheel variator for the division of torque and power, whereby the two output disks are not connected rigidly but are connected via one or more bearings.

According to the invention, the disk pairs of the friction wheel variator can each be energized independently.

According to the invention, the concept eliminates the necessity for an all-wheel distributor, such as that of a toroid differential. In addition, a long side shaft is no longer necessary for the transfer of power, resulting in a simple and compact construction.

The invention is explained in greater detail below by means of the attached drawings. They show:

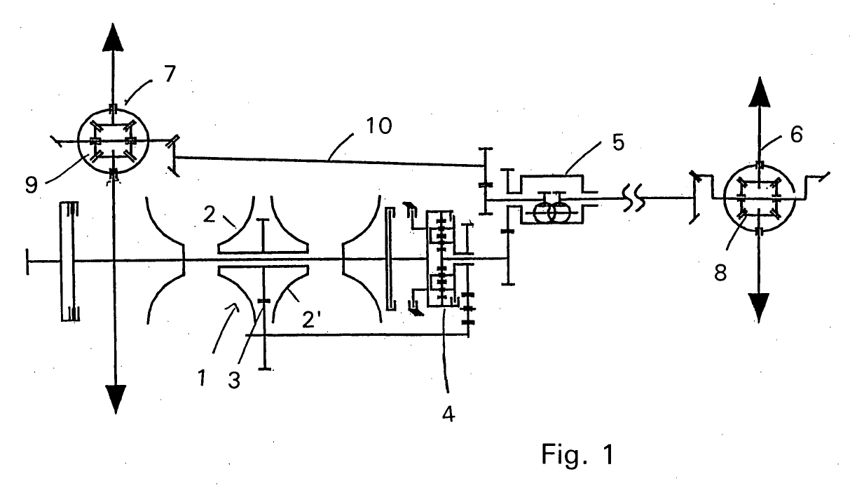

FIG. 1 is a schematic depiction of an all-wheel toroid transmission according to prior art; and

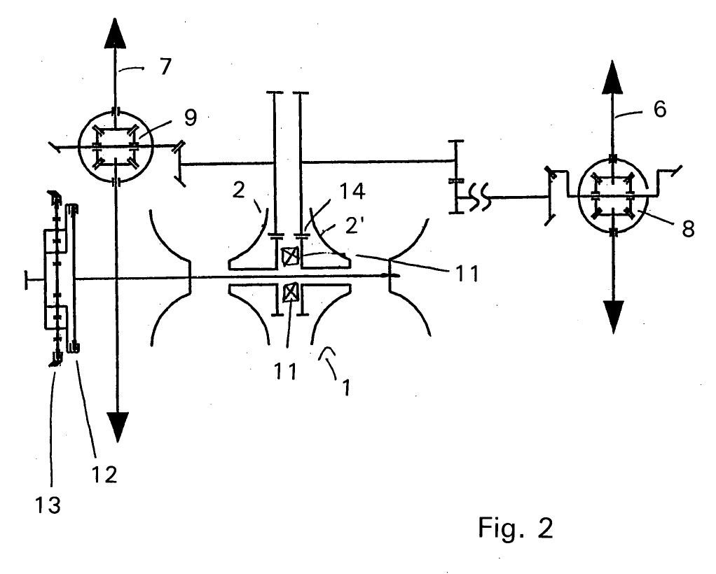

FIG. 2 is a schematic depiction of a preferred embodiment of an all-wheel toroid transmission for a vehicle according to the present invention.

According to FIG. 1, an all-wheel toroid transmission comprises a friction wheel variator 1, according to prior art, whose two output discs 2, 2′ are rigidly connected to each other, a transmission level 3, as well as a summing transmission 4 where the output power from the friction wheel variator 1 and the drive power are totaled and forwarded to a transfer gearbox 5. There is no power bifurcation during the drive level HIGH; the power is transferred in its entirety to the summing transmission 4 via the variator 1 that circulates in the block operation. The transfer gearbox 5 then distributes the torque and the power to a rear axle 6 and a front axle 7 which, in turn, are each respectively provided with differentials 8 and 9. A long side shaft 10 is provided for the power transfer to the front axle 7, which disadvantageously requires a large amount of construction space.

According to FIG. 2, the all-wheel toroid transmission does not contain a transfer gearbox. This is possible because the two output disks 2, 2′ of the friction wheel variator 1 are not rigidly connected with each other but are coupled to one another via a support bearing 11 whereby the output disk 2 is connected to the front axle 7 and the second output disk 2′ is connected to the rear axle 6, so that the torque and the power are distributed to both axles by the friction wheel variator 1.

The bearings 11 are supported according to the invention by a housing wall between the output disks 2, 2′. As long as both output disks 2, 2′ rotate at the same speed, the revolutions and the reaction forces are transferred without losses via bushings from one disk pair to the other disk pair. If they rotate at different speeds—for example, if there is ice under one axle of the vehicle, the axial forces are supported by the housing wall via the bearing 11.

According to the invention, both disk pairs of the friction wheel variator 1 can be energized or actuated separately. This means that two separate energizing devices and two separate contact pressure devices are provided, one for each of the two output disks 2, 2′. In addition, the input and output revolutions of both disk couples are measured within the framework of the energizing process.

A forward coupling 12 and a reverse brake 13 of the transmission are shown in FIG. 2, according to the invention. A transmission level 14 can be provided between the output disks 2, 2′ and the corresponding vehicle axles 6, 7.

A power bifurcation can be provided within the framework of additional embodiments of the transmission according to the invention, whereby additional switch elements are required for this purpose.

Reference Numbers

1 friction wheel variator

2, 2′ output disks

3 transmission level

4 summing transmission

5 transfer gearbox

6 rear axle

7 front axle

8 differential

9 differential

10 side shaft

11 support bearing

12 forward coupling

13 reverse brake

14 transmission level

1-7. (CANCELED)

8. An all-wheel toroid transmission for a vehicle with a friction wheel variator (1), wherein distribution of torque and power to a front axle (7) and a rear axle (6) of the vehicle takes place through the friction wheel variator (1).

9. The all-wheel toroid transmission according to claim 8, wherein output disks (2, 2′) of the friction wheel variator (1) are connected to each other via support bearings (11) and wherein a first output disk (2) is connected to the front axle (7) and a second output disk (2′) is connected to the rear axle (6) of the vehicle, so that the torque and the power of the friction wheel variator (1) are distributed on the front and rear axles (6, 7).

10. The all-wheel toroid transmission according to claim 8, wherein the support bearings (11) are supported by a housing wall between the first and second output disks (2, 2′).

11. The all-wheel toroid transmission according to claim 8, wherein the first and second output disks (2, 2′) of the friction wheel variator (1) can be energized separately, whereby two energizing devices and two contact pressure devices are provided.

12. The all-wheel toroid transmission according to claim 8, wherein a transmission level (14) is provided between the first and second output disks (2, 2′) of the friction wheel variator (1) and the corresponding front and rear axles (6, 7).

13. The all-wheel toroid transmission according to claim 8, wherein input and output revolutions of both the first and second output disks (2, 2′) can be measured separately.

14. The all-wheel toroid transmission according to claim 8, wherein a power bifurcation is provided.

15. An all-wheel toroid transmission for a vehicle with a friction wheel variator (1), the all-wheel toroid transmission including an input supplying torque and power to first and second output discs (2, 2);
wherein the first output disc (2) distributes torque and power solely to a front axle (7) and the second output disc (2′) distributes torque and power solely to a rear axle (6) of the vehicle.

16. An all-wheel toroid transmission for a vehicle with a friction wheel variator (1), the all-wheel toroid transmission including an input supplying torque and power to first and second output discs (2, 2);
wherein at least one bearing, supported by a transmission housing wall, is located between the first and second output discs (2, 2) to facilitate relative rotation therebetween; the first output disc (2) distributes torque and power solely to a front axle (7) and the second output disc (2′) distributes torque and power solely to a rear axle (6) of the vehicle.
